(19) United States
(12) Patent Application Publication
(10) Pub. No.: US 2010/0050089 A1
(43) Pub. Date: Feb. 25, 2010

(54) WEB BROWSER SYSTEM OF MOBILE COMMUNICATION TERMINAL, USING PROXY SERVER

(75) Inventors: Jin Cheon KIM, Yongin-si (KR); Kwang Yul SEO, Seongnam-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: COMPANY 100, INC., Seongnam-si (KR)

(21) Appl. No.: 12/543,272

(22) Filed: Aug. 18, 2009

(30) Foreign Application Priority Data
Aug. 20, 2008 (KR) 10-2008-0081236
Aug. 20, 2008 (KR) 10-2008-0081238
Aug. 6, 2009 (KR) 10-2009-0072289

(51) Int. Cl. G06F 3/00; G06F 15/16

(52) U.S. Cl. 715/749; 709/203

(57) ABSTRACT

A web browser system includes a mobile communication terminal configured to implement decoding and parsing for HTML and CSS binary files, execute a JavaScript bytecode, decode an image file, and implement rendering for respective results, for web browsing of a web browser built therein; a proxy server configured to, in correspondence to a web address transmitted thereto, transmit a page access command to a web server of the corresponding web address via a wired network, implement grammar indentifying binary encoding for HTML and CSS transmitted from the web server to decrease capacity, convert quality for an image file to decrease capacity, compile JavaScript into a bytecode to decrease capacity, and transmit those files to the mobile communication terminal via a wireless network; and a web server configured to transmit files constituting a web page including the HTML, CSS, JavaScript and image files, to the proxy server.

### BACKGROUND OF THE INVENTION

1. Field of the Invention

The present invention relates to a technique for improving the speed of a web browser for a mobile communication terminal, and more particularly, to a web browser system of a mobile communication terminal, using a proxy server, which can improve the speed of a web browser using a proxy server when accessing Internet information through the web browser in a mobile communication terminal.

2. Description of the Related Art

These days, a web browser is considered as an essential tool for accessing the Internet in a mobile communication terminal such as a mobile phone, and so forth, and the importance of the web browser is further elevated due to the activation of the wireless Internet. Recently, as the size of the window of a mobile communication terminal is increased and the performance of hardware such as a central processing unit (CPU) is improved, the supply of a smartphone, which is equipped with an operation system (OS) capable of realizing complicated functions, is significantly increased. Due to this fact, customers' demands are not limited to very simple web sites which are dedicated for mobile phones and employ the existing WAP standards, and instead, the customers' demands for using web sites which are complicated as in personal computers (PCs) using the HTML (hypertext mark-up language) standards are gradually increased.

In the conventional web browser systems adopted in mobile communication terminals such as mobile phones and the likes, a method of independently processing data mainly in the mobile communication terminals as in Internet Explorer, iPhone Safari, Opera Mobile, etc. has been used. While these independent processing type web browser systems have advantages in that the systems can be easily realized, they have mortal disadvantages in that, when it is necessary to access a complicated web page of 1 MB or over, a time of 8 seconds or longer is required for data transmission in a wireless network under a wireless bandwidth condition of 1 Mbps of the present time so that the overall processing speeds of the web browser systems markedly decrease.

More recently, in order to cope with this problem, methods have been proposed in the art in which a proxy server is installed between a mobile communication terminal and a web contents server to be finally accessed and information is processed using the proxy server. A representative example of these methods is WebView of Logicplant Co., Ltd. In WebView, the browser result momentarily processed in a proxy server is transmitted to a terminal as an image having a small data size so that the speed at which the web page is viewed on the terminal can be remarkably improved.

However, since the WebView method is on the basis of a simple image, difficulties exist in processing moving pictures. Also, when accessing an interactive web application program using AJAX (asynchronous JavaScript and XML), since information is processed on the basis of a proxy image, disadvantages are caused in that a reaction speed markedly decreases. Further, because web browser functions are all processed in the proxy server, if the number of terminal users using these functions increases, the installation of the proxy server should be drastically increased in correspondence to the increase in the number of terminal users, whereby an economic burden cannot but conspicuously increase

Therefore, until the bandwidths of wireless networks and the performance of terminals are significantly improved, a quick and effective web browser capable of addressing the disadvantages of the existing independent processing type web browser and the proxy processing type web browser is demanded in mobile communication terminals.

Moreover, a web page which is frequently accessed by users has more than 100 files. Accordingly, how quickly a number of files constituting the web page are transmitted to a terminal is an important factor that determines the performance of a web browser of the wireless terminal which is limited in the bandwidth of a network. Thus, in order to improve the speed of a web browser of a mobile communication terminal which has a great speed difference compared to a PC browser, a technique for quickly transmitting files constituting a web page to a terminal is required.

### SUMMARY OF THE INVENTION

Accordingly, the present invention has been made in an effort to solve the problems occurring in the related art, and an object of the present invention is to improve the processing speed of a web browser of a mobile communication terminal by decreasing an amount of wireless transmission data using binary encoding of a proxy server in the mobile communication terminal.

Another object of the present invention is to improve the processing speed of a web browser of a mobile communication terminal by quickly receiving the files of a web page to be accessed and transmitting the files to the mobile communication terminal using a prefetching method in a proxy server.

In order to achieve the above objects, according to one aspect of the present invention, there is provided a web browser system of a mobile communication terminal, using a proxy server, comprising a mobile communication terminal configured to implement decoding and parsing for HTML and CSS binary files transmitted from a proxy server, execute a JavaScript bytecode, decode an image file, and implement rendering for respective results, for the sake of web browsing of a web browser built therein; a proxy server configured to, in correspondence to a web address transmitted from the mobile communication terminal, transmit a page access command to a web server of the corresponding web address via a wired network, implement grammar indentifying binary encoding for HTML and CSS transmitted from the web server to decrease capacity, convert quality for an image file to decrease capacity, compile JavaScript into a bytecode to decrease capacity, and transmit those files to the mobile communication terminal via a wireless network; and a web server configured to transmit files constituting a web page including the HTML, CSS, JavaScript and image files, to the proxy server in response to the access command transmitted from the proxy server.

In order to achieve the above objects, according to another aspect of the present invention, there is provided a web browser system of a mobile communication terminal, using a proxy server, comprising a mobile communication terminal configured to implement decoding and parsing for HTML and CSS binary files transmitted from a proxy server, execute a JavaScript bytecode, decode an image file, and implement rendering for respective results, for the sake of web browsing of a web browser built therein; a proxy server configured to receive main files from a web server corresponding to a web address transmitted from the mobile communication terminal, transmit the main files to the mobile communication terminal, receive files linked with the main files from the web server, transmit the linked files to the mobile communication terminal, and, when the web browser requests again a previously requested web page, transmit prefetched files of the corresponding web page; and a web server configured to transmit files constituting a web page including the HTML, CSS, JavaScript and image files, to the proxy server in response to the access command transmitted from the proxy server.

In order to achieve the above objects, according to still another aspect of the present invention, there is provided a web browser system of a mobile communication terminal, using a proxy server, comprising a mobile communication terminal configured to implement decoding and parsing for ML and CSS binary files transmitted from a proxy server, execute a JavaScript bytecode, decode an image file, and implement rendering for respective results, for the sake of web browsing of a web browser built therein, the mobile communication terminal having a local prefetching module and receiving files prefetched in the proxy server before implementing local prefetching; a proxy server configured to receive main files from a web server corresponding to a web address transmitted from the mobile communication terminal, transmit the main files to the mobile communication terminal, receive files linked with the main files from the web server, transmit the linked files to the mobile communication terminal, and, when the web browser requests again a previously requested web page, transmit prefetched files of the corresponding web page; and a web server configured to transmit files constituting a web page including the HTML, CSS, JavaScript and image files, to the proxy server in response to the access command transmitted from the proxy server.

### BRIEF DESCRIPTION OF THE DRAWINGS

The above objects, and other features and advantages of the present invention will become more apparent after a reading of the following detailed description taken in conjunction with the drawings, in which:

FIG. 1 is a block diagram illustrating a web browser system of a mobile communication terminal, using a proxy server, in accordance with an embodiment of the present invention;

FIG. 2 is a detailed block diagram of a web browser in FIG. 1;

FIG. 3 is a detailed block diagram of a proxy server illustrating binary encoding of HTML sources on the basis of grammar identification;

FIG. 4 is a detailed block diagram of a proxy server illustrating binary encoding of CSS sources on the basis of grammar identification;

FIG. 5 is a block diagram illustrating prefetching of a web browser using a proxy server in accordance with another embodiment of the present invention;

FIG. 6 is a block diagram illustrating prefetching using local prefetching in a web browser in accordance with still another embodiment of the present invention;

FIG. 7 is a block diagram illustrating storing and merging processing of image files using a proxy server; and

FIG. 8 is a block diagram illustrating automatic detection of HTML encoding using a proxy server.

### DETAILED DESCRIPTION OF PREFERRED EMBODIMENTS

Reference will now be made in greater detail to preferred embodiments of the invention, examples of which are illustrated in the accompanying drawings. Wherever possible, the same reference numerals will be used throughout the drawings and the description to refer to the same or like parts.

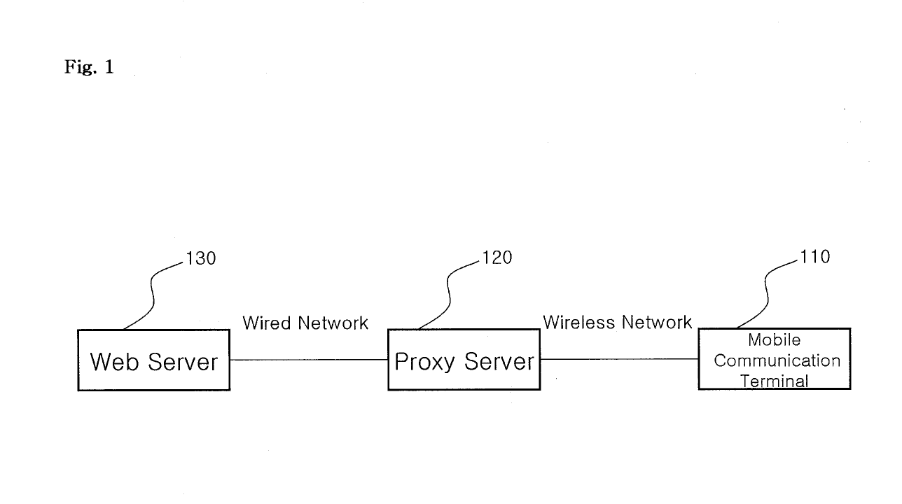

FIG. 1 is a block diagram illustrating a web browser system of a mobile communication terminal, using a proxy server, in accordance with an embodiment of the present invention. Referring to FIG. 1, the web browser system includes a mobile communication terminal 110, a proxy server 120, and a web server 130.

First, if a user inputs the address of a web to be accessed, on the web browser of the mobile communication terminal 110, the web address is transmitted to the proxy server 120 via a wireless network and the Internet.

The proxy server 120 receives the web address from the mobile communication terminal 110 and transmits an access command for a corresponding web page to the web server 130 having the corresponding address. The access command is a command according to the HTTP protocol.

In correspondence to the access command transmitted from the proxy server 120, the web server 130 transmits files constituting the web page, such as HTML, CSS (cascading style sheet), JavaScript, image files, and the likes, to the proxy server 120.

The proxy server 120 receives the HTML, CSS, JavaScript, image files, and the likes from the web server 130, and implements HTML grammar identifying binary encoding, CSS grammar identifying binary encoding, JavaScript bytecode generation, and image quality conversion functions. Then, the proxy server 120 transmits the conversion details to the mobile communication terminal 110 via the wireless network.

At this time, the HTML, CSS and image files can be consecutively transmitted to the mobile communication terminal 110 while they are converted in the proxy server 120. Thus, since the mobile communication terminal 110 can receive and process data while the HTML, CSS and image files are processed, the processing time of the web browser can be shortened correspondingly.

The web browser of the mobile communication terminal 110 implements decoding, parsing and rendering for the HTML and CSS binary files received from the proxy server 120 and image processing and rendering for the received image files, and executes the received JavaScript bytecode through a JavaScript execution engine and the image files through an image file decoding engine. These processing results are displayed on the display device of the mobile communication terminal 110.

Preferably, the network which connects the web server 130 and the proxy server 120 is a wired network which has a wide bandwidth and a high transmission speed, and the network which connects the proxy server 120 and the mobile communication terminal 110 is a wireless network which has a relatively slow transmission speed, such as mobile communication service, WiFi, wireless LAN, and so forth.

The proxy server 120 converts web page constituting component elements, such as HTML, CSS, image, JavaScript files, and so forth, into files having capacities less than original capacities, and transmits the converted files to the mobile communication terminal 110 via a wireless network having a narrow bandwidth. Due to this fact, the same effect as substantially enlarging the bandwidth of the wireless network can be attained.

For example, in the case of the Naver web site http://www.naver.com which is one of the most favorite web sites accessed by a large number of users in Korea, the total capacity of the files to be received by the web browser is about 1 MB. The 1 MB files are composed of about 200 KS of HTML, about 50 KB of CSS, about 250 KB of JavaScript, and about 500 KB of image files.

The proxy server 120 identifies the grammars of the respective HTML and CSS and encodes the grammars into binary type files, and by this fact, the capacities of the files are decreased to ¼ of original capacities. Also, the proxy server 120 analyzes the JavaScript and generates a corresponding bytecode, and by this fact, the capacity of the original JavaScript file is decreased to ¼. Further, as the proxy server 120 lowers the quality of the image files, the capacity of the image files is decreased to ¼ compared to the original files.

As a consequence, the 1 MB files transmitted to the proxy server 120 is transmitted to the mobile communication terminal 110 by being converted to 250 KS as a ¼ level.

In the case that the mobile communication terminal 110 uses a network of 1 Mbps wireless bandwidth, it takes 8 seconds to transmit 1 MB files to the mobile communication terminal 110 in the conventional art.

Conversely, in the case that the 1 MB files are transmitted to the mobile communication terminal 110 via the proxy server 120 and the wireless network, the capacity of the files is decreased to 250 KB through the above-described procedure, and the transmission time is also decreased to 2 seconds as ¼ of the original transmission time.

Hence, the same effect as four times increasing a wireless bandwidth is actually attained. Due to this fact, the processing speed of the web browser on the mobile communication terminal 110 is improved correspondingly.

Further, as the web browser of the mobile communication terminal 110 processes the web contents files which are processed in the proxy server 120 as described above, the processing speed can be improved for the following reasons.

Since the web browser uses a grammar identification-based binary encoding method for HTML and CSS files, it is not necessary to implement a function for identifying the grammars of the HTML and CSS files as in the conventional art. In the case of JavaScript, because the JavaScript is analyzed in advance in the proxy server 120 and is transmitted to the web browser in the type of bytecode, it is not necessary to analyze the JavaScript in the mobile communication terminal 110, and the JavaScript can be immediately executed. Since the image files are transmitted to the mobile communication terminal 110 in the state in which the quality of the image files is decreased, the processing speed of an image file decoding engine is improved.

In general, the proxy server 120 has a central processing unit which has very excellent performance compared to the mobile communication terminal 110. In consideration of this fact, by causing the proxy server 120 to implement functions such as grammar analysis, etc., an amount of load to be applied to the web browser of the mobile communication terminal 110 is decreased correspondingly.

In the conventional information processing method such as WebView, all the internal functions of the web browser are implemented in the proxy server, and only the results are transmitted to the mobile communication terminal. Thus, difficulties exist in reproducing moving pictures at a normal speed, and mortal defects are caused in that a reaction time increases when accessing a web application program using AJAX (asynchronous JavaScript and XML). Conversely, in the proxy method adopting the grammar identifying binary encoding according to the present invention, since only the grammar analysis and file conversion are implemented in the proxy server 120 and all the remaining browser functions are implemented in the mobile communication terminal 110, a problem is not caused when reproducing moving pictures and accessing the web application program using AJAX.

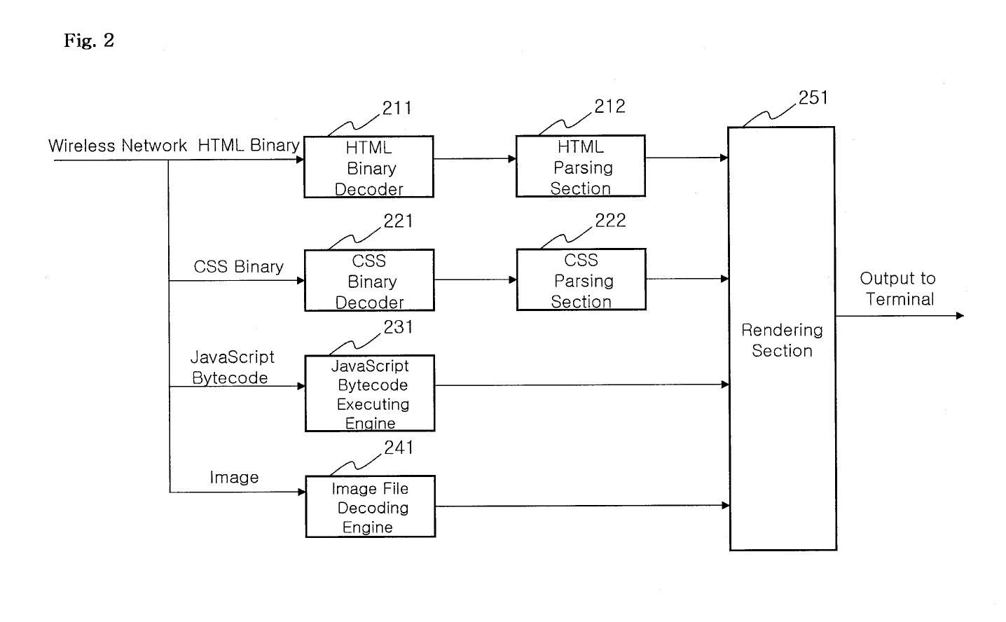

FIG. 2 is a detailed block diagram of the web browser in the mobile communication terminal 110. Referring to FIG. 2, the web browser includes an HTML binary decoder 211 and an HTML parsing section 212, a CSS binary decoder 221 and a CSS parsing section 222, a JavaScript bytecode executing engine 231, an image file decoding engine 241, and a rendering section 251.

The HTML binary, CSS binary, JavaScript bytecode, image files, etc., which are transmitted from the proxy server 120 via the wireless network and are received by the mobile communication terminal 110, are processed by corresponding blocks as described below.

The HTML binary decoder 211 decodes and restores the grammar identification-encoded HTML binary to the original HTML. The HTML parsing section 212 parses the restored HTML to be suited for rendering processing.

The CSS binary decoder 221 decodes and restores the grammar identification-encoded CSS binary to the original CSS. The CSS parsing section 222 parses the restored CSS to be suited for rendering processing.

The JavaScript bytecode executing engine 231 receives and executes the JavaScript bytecode.

The image file decoding engine 241 receives and executes the image files.

The rendering section 251 renders the HTML, CSS, JavaScript and image files executed as described above, and outputs them to the display device of the mobile communication terminal 110.

The HTML binary decoder 211 implements a function opposite to the HTML grammar identifying binary encoding implemented in the proxy server 120, and since the grammar analysis for the HTML has already been implemented in the proxy server 120, grammar analysis called lexing can be omitted.

However, since grammar analysis and parsing are usually realized in one block, in consideration of convenience in realization, lexing can be implemented along with parsing by restoring the original HTML.

Similarly, the CSS binary decoder 221 can selectively determine whether to implement lexing in the same manner as in the HTML binary decoder 211.

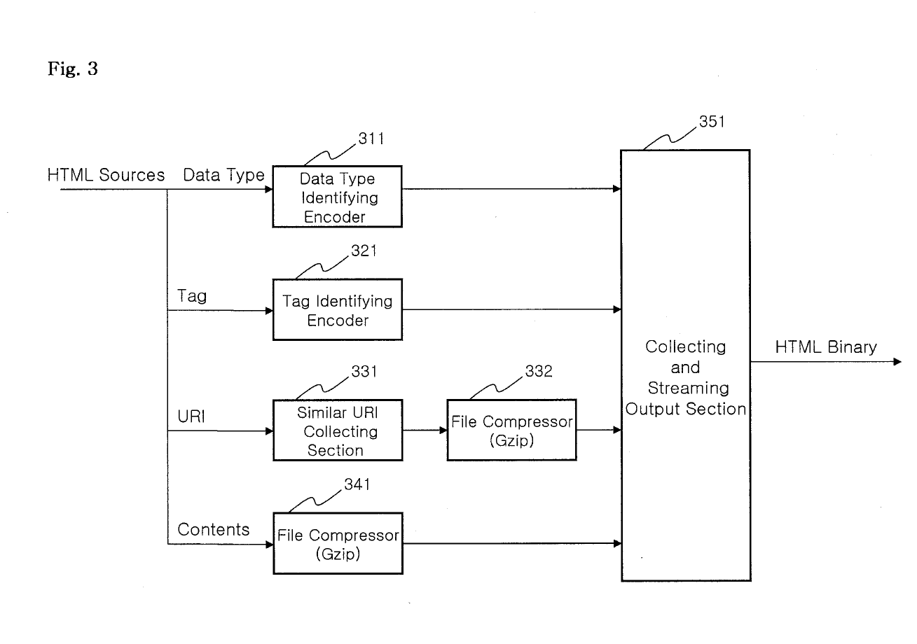

FIG. 3 is a block diagram of the proxy server 120 illustrating binary encoding of HTML sources on the basis of grammar identification. Referring to FIG. 3, the proxy server 120 includes a data type identifying encoder 311, a tag identifying encoder 321, a similar URI (uniform resource identifier) collecting section 331 and a file compressor 332, a file compressor 341, and a collecting and streaming output section 351.

The HTML sources inputted to the proxy server 120 are composed of a data type, a tag, an URI and contents which are respectively encoded and collected in the proxy server 120 in conformity with their characteristics. The collected data can be transmitted to the mobile communication terminal 110 in a streaming type for the sake of quick transmission.

The data type identifying encoder 311 identifies a data type from the inputted HTML sources and encodes the data type into a binary code.

The tag identifying encoder 321 identifies a tag from the inputted HTML sources and encodes the tag into a binary code.

The similar URI collecting section 331 collects a similar URI from the inputted HTML sources. The file compressor 332 compresses the URI collected and transmitted by the similar URI collecting section 331, using a file compressor having a high compression rate, such as a Gzip, and outputs the compressed URI as a binary code.

The file compressor 341 compresses contents data among the inputted HTML sources, using a general file compressor, such as a Gzip, and outputs the compressed contents data as a binary code.

The collecting and streaming output section 351 collects the information outputted as binary codes from the respective components, and outputs streaming type HTML binary codes.

An encoding algorithm in the proxy server 120 will be described below in further detail by way of an example.

The data type is data that represents the information of numbers, colors, and so forth in the HTML sources. The data type is encoded and is compressed into a binary. This is a method of decreasing an amount of data by converting a number represented by characters into an integer. For example, when the width of an image is expressed as width=“100”, since “100” has five characters, it corresponds to 5 byte information, In this regard, since 100 is converted into 1 byte information when it is represented in an integer, 5 byte data can be converted into 1 byte data. In this case, the amount of bytes required for the representation in conformity with the magnitude of a number expressed in characters should be assigned.

As a method for encoding the HTML tag, an encoding method, in which a succeeding tag is determined according to a preceding tag, is adopted. For example, in the case of <ul> and <li>, only three tags <li>, </li> and </ul> can succeed the tag <ul>. Accordingly, since the tags succeeding the tag <ul> can be coded using only 2 bits, 4 bytes for representing the tag <li> can be decreased to 2 bits. Unlike this, in the case where succeeding tags can be numerous, because the probability of a tag to succeed can be known in advance to some extent through the analysis of various web pages, a method, in which a short bit is designated to a frequently succeeding tag, and a long bit is designated to a not frequently succeeding tag, is adopted, whereby it is possible to reduce an amount of data for representing tags.

The URI representing URL/URN indicates an external source address which mainly has image files and the likes. When the mobile communication terminal 110 brings image files from the web server 130, it generally brings the image files from web servers which have similar addresses. For example, when observing URI information of HTML of http://www.naver.com, most address information has similar characteristics as in http://www.naver.com/image/a.jpg, http://www.naver.com/image/b. jpg, and http://www.naver.com/image/c.jpg. In this regard, in the case of a portal site such as http://www.naver.com, since it brings a considerable amount of external sources, it has a characteristic in that an amount of the URI data is substantial.

In the present invention, in consideration of this fact, as described above, the similar URI collecting section 331 collects similar URI. The file compressor 332 compresses the URI collected and transmitted by the similar URI collecting section 331, using a file compressor having a high compression rate, such as a Gzip, and outputs the compressed URI as a binary code. According to this fact, it is possible to obtain a binary having a high compression rate with respect to URI. In particular, as an amount of similar URI increases, it is possible to obtain a binary having a high compression rate through the Gzip having a high compression ratio.

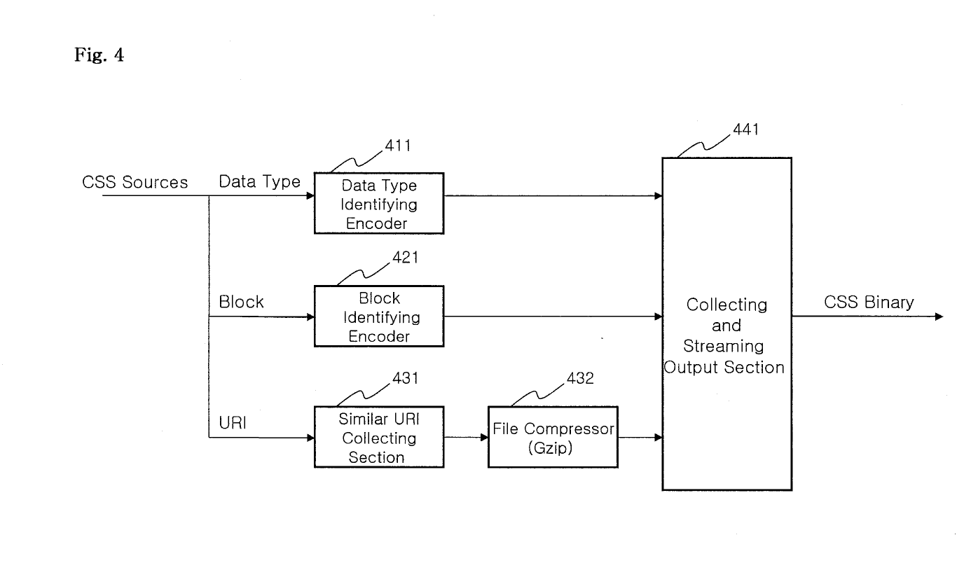

FIG. 4 is a detailed block diagram of the proxy server 120 illustrating binary encoding of CSS sources on the basis of grammar identification. Referring to FIG. 4, the proxy server 120 includes a data type identifying encoder 411, a block identifying encoder 421, a similar URI collecting section 431 and a file compressor 432, and a collecting and streaming output section 441.

The data type identifying encoder 411 identifies a data type in CSS sources inputted from the web server 130, and encodes the data type as a binary code.

The block identifying encoder 421 identifies a script block in the CSS sources inputted from the web server 130, and encodes the script block as a binary code.

The similar URI collecting section 431 collects a similar URI from the CSS sources inputted from the web server 130. The file compressor 432 compresses the URI collected and transmitted by the similar URI collecting section 431, using a general file compressor, and outputs the compressed URI as a binary code.

The collecting and streaming output section 441 collects the information outputted as binary codes from the respective components, and outputs streaming type CSS binary codes.

When comparing the CSS grammar identifying binary encoding structure shown in FIG. 4 and the binary encoding structure based on grammar identification of HTML sources shown in FIG. 3, they are similar to each other except different grammars and absence of contents.

Other files such as flash and the like, excluding HTML, CSS, JavaScript, image files, are transmitted to the mobile communication terminal 110 as they are without being modified in the proxy server 120 or are transmitted by being compressed by a conventional file compressor. In conformity with this, the web browser of the mobile communication terminal 110 receives and processes the transmitted files.

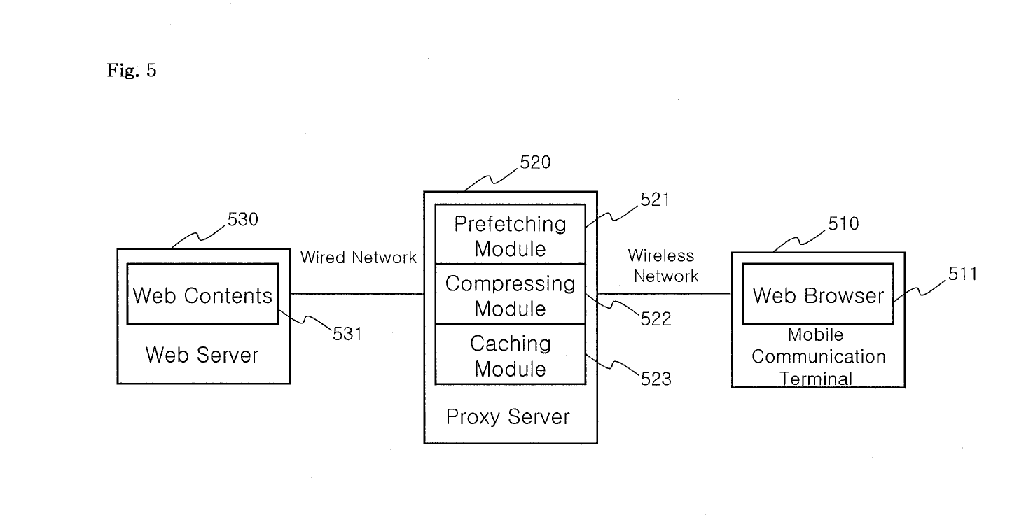

FIG. 5 is a block diagram illustrating prefetching of a web browser system of a mobile communication terminal, using a proxy server, in accordance with another embodiment of the present invention. Referring to FIG. 5, the web browser system includes a mobile communication terminal 510, a proxy server 520, and a web server 530.

The mobile communication terminal 510 has a web browser 511 built therein and is connected with the proxy server 520 via a wireless network.

The proxy server 520 has a prefetching module 521 built therein and is connected with the web server 530 via a wide bandwidth wired network.

The web server 530 has contents such as web pages, etc. built therein.

The proxy server 520 receives a web address from the mobile communication terminal 510 and transmits a web page access command to the web server 530 having the corresponding address. In conformity with this, the web server 530 transmits a main HTML file of the corresponding web page to the proxy server 520. Thereupon, the proxy server 520 receives the main HTML file and transmits the main HTML file to a web browser 511 of the mobile communication terminal 510. Also, the proxy server 520 analyzes the main HTML file and, in order to receive linked files, transmits a corresponding command to the web server 530. In response to the command, the web server 530 transmits the linked files to the proxy server 520, and the proxy server 520 immediately transmits those linked files to the mobile communication terminal 510 such that the web browser 511 can process the linked files.

The prefetching in the proxy server 520 is linked with caching and compressing. The files transmitted from the web server 530 can be cached in the proxy server 520. Therefore, in the event that the web browser 511 requests again the same web page as a previously requested web page to the proxy server 520, the files cached in the proxy server 520 can be immediately used.

At this time, since the proxy server 520 transmits the prefetched web page files to the web browser 511 via a wireless network by compressing the files through binary encoding, etc., the capacity of the files to be transmitted is decreased. Accordingly, the processing performance of the web browser 511 can be improved, and the capacity of a storage device such as a hard disc, and the like can be saved.

For example, in the case of the Naver web site http://www.naver.com which is one of the most favorite web sites accessed by a large number of users in Korea, the number of entire files to be received by the web browser 511 is around 200.

If a user inputs the address http://www.naver.com on the web browser 511 of the mobile communication terminal 510, the proxy server 520 receives the address and transmits a corresponding web page access command to the web server 530. Thereafter, the web server 530 transmits the main HTML (main.html), main JavaScript (main.js), main CSS (main.css) files of the corresponding web page to the proxy server 520.

At this time, the proxy server 520 transmits the main.html, main.js and main.css files to the mobile communication terminal 510. At the same time, the proxy server 520 analyzes those files, finds the addresses of linked files, transmits file access commands to the web servers of the corresponding addresses, and receives 200 linked files. The proxy server 520 immediately transmits the received files to the web browser 511 of the mobile communication terminal 510 so that the files are executed.

Accordingly, when compared to the case in which the web browser 511 receives the files by requesting those files to the proxy server 520, a standby time is significantly shortened.

Due to the fact that the proxy server 520 implements analyzing and modifying tasks in a manner such that JavaScript codes which do not influence an HILL page layout are positioned behind the HTML, an initial page layout rendering time in the mobile communication terminal 510 can be shortened. Due to this fact, the reactivity sensed by the user can be improved.

For example, when logging in the Naver site, it takes 4 seconds for the mobile communication terminal 510 to code a user's password, and during this time, the web browser 511 cannot implement other layout tasks. Thus, a time required for the user to initially check the contents of a page is lengthened by 4 seconds. In a case similar to this, JavaScript codes, which influence HTML elements not visible before receiving a user's input, and codes, which are commonly included in all pages and are not used in a current page, can be modified to be positioned behind. For instance, there are instrumental functions used for realizing the control of a web editor, etc., and a password cord used when the user logs in is included in this classification as well.

If it is possible to confirm that these kinds of codes do not exert any influence on a page layout, those codes can be positioned behind so that the user can more quickly check the contents of a page. The confirmation is made possible by analyzing the classes of HTML tags, style attributes, CSS files and JS files referred to by HTML files, and JavaScript tags in the HTML files.

The JavaScript codes which influence the page layout can be generally divided into four classifications including 1) codes which add sub-attributes to or modify the style attributes of HTML elements, 2) codes which add or modify class attributes of HTML elements, 3) codes which create new elements through createElement functions of document elements, add the new elements using appendChild functions of other elements or remove sub items using removeChild functions of HTML elements, and 4) codes which modify innerHTML attributes of HTML elements.

In order to distinguish codes which do not exert any influence on a page layout and implement a number of calculations, it is necessary to find codes which do not belong to the four classifications and implement numerous tasks with respect to for control flow statements or while control flow statements, arrangements and character strings, and codes which start the tasks and then check whether these codes belong to the four classifications.

The codes, which are commonly included in the HTML pages of a site but are not used in a current HTML, are mainly generated in the form of functions. In the case of these functions, if no portions are called, they can be arranged behind. In the case of codes for non-visible portions, it is necessary to first distinguish HTML elements in which the visible attributes or display attributes of CSS are hidden or none and then distinguish codes which do not modify their visible attributes or display attributes.

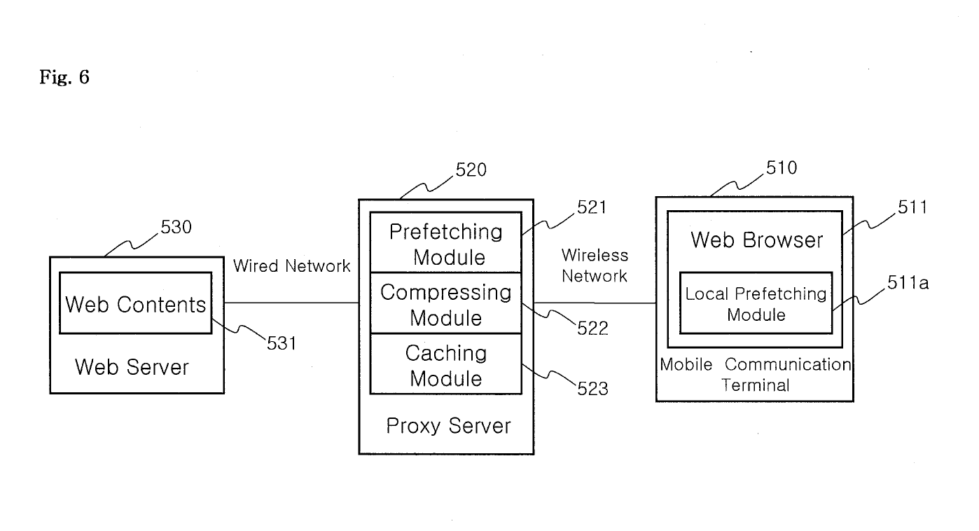

FIG. 6 is a block diagram illustrating prefetching using local prefetching in a web browser of a mobile communication terminal in accordance with still another embodiment of the present invention.

A web browser 511 of a mobile communication terminal 510 has a local prefetching module 511a built therein, and transmits a command for receiving web page files prefetched in a proxy server 520 before implementing a local prefetching task using the local prefetching module 511a.

The local prefetching in the web browser 511 is implemented in a manner similar to the prefetching in the proxy server 520.

That is to say, the local prefetching module 511a of the web browser 511 analyzes the main files of a web page to be accessed, identifies address link information of files to be received, generates an access command based on the identified address link information, and transmits the access command to the proxy server 520.

As a consequence, corresponding files are transmitted from a caching module 523 of the proxy server 520 to the local prefetching module 511a, and the local prefetching module 511a transmits the received corresponding files to the web browser 511.

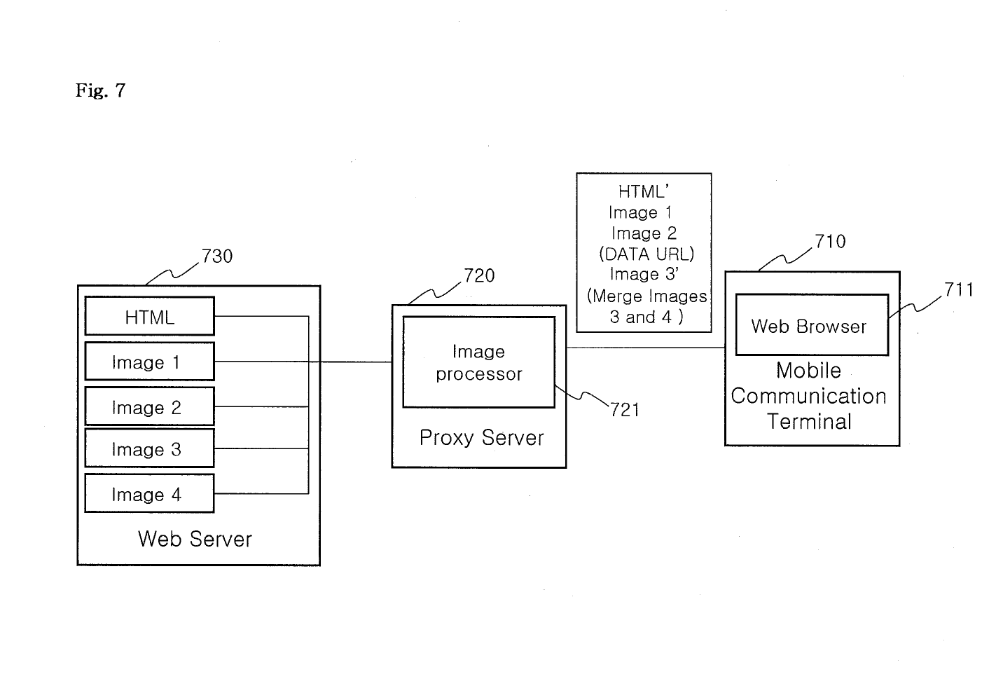

FIG. 7 is a block diagram illustrating storing and merging processing of image files using a proxy server.

HTML refers to various images using an <img> tag or CSS, and a web browser 711 of a mobile communication terminal 710 must receive all the images referred to by the HTML from a browser through separate HTTP requests and replies. Because a wireless network between the mobile communication terminal 710 and a proxy server 720 has a low communication speed, if the number of HTTP requests from the web browser 711 increases, a loading speed decreases correspondingly.

The proxy server 720 includes non-overlapping small images into HTML files in the form of DATA URL or merges a number of images into one image. Accordingly, the number of HTTP requests and replies required for the display of images is decreased, and the page loading speed of the web browser 711 of the mobile communication terminal 710 is improved.

It is preferred that, when a number of images are merged into one image as described above, HTML and CSS codes which refer to the merged image be corrected so that portions corresponding to original images can be taken.

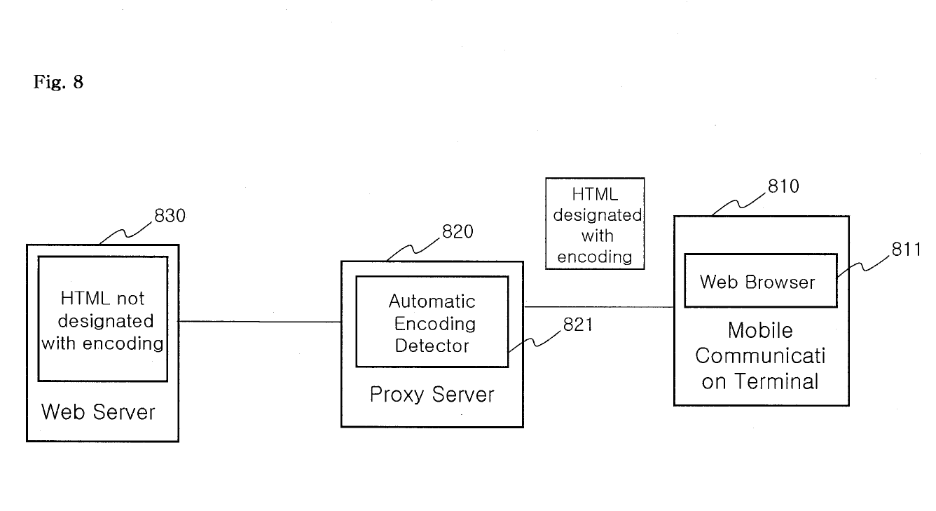

FIG. 8 is a block diagram illustrating automatic detection of HTML encoding, using a proxy server.

In general, a web browser 811 in a mobile communication terminal 810 should employ an automatic encoding detector in order to properly display HTML files which are not designated with encoding. Moreover, in order to increase the precision of automatic detection, an increased period of time should be used for the detection of encoding. However, in the web browser 811 of the mobile communication terminal 810 which has limited resources, limitations necessarily exist in using an increased period of time.

In consideration of this fact, in the present invention, automatic detection of encoding is implemented in a proxy server 820 using an automatic encoding detector 821. By doing this, encoding can be more precisely detected within a short period of time using the affluent sources of the proxy server 820. Also, because the encoding detection function is not implemented in the web browser 811 of the mobile communication terminal 810, an available service time of a battery in the mobile communication terminal 810 can be correspondingly extended.

As is apparent from the above description, in the present invention, since a proxy server implements grammar identification encoding of HTML/CSS, JavaScript bytecode conversion, and image file quality conversion, etc., an amount of data to be received by a mobile communication terminal can be significantly decreased. Accordingly, the speed of a browser in a mobile communication terminal using a limited wireless bandwidth can be considerably improved.

Also, due to the fact that only grammar analysis and file conversion are implemented in a proxy server and all the remaining browser functions are implemented in a mobile communication terminal, the cost of the proxy server can be reduced, and moving picture reproduction and the execution of a web application program using AJAX can be easily implemented.

Further, since a prefetching method is used in which the files of a web page to be accessed under a limited wireless network bandwidth condition are received in advance using a proxy server and are then supplied to the web browser of a mobile communication terminal, the processing speed of the web browser of a mobile communication terminal can be improved.

Moreover, because files are compressed and cached in a proxy server and are then transmitted to a mobile communication terminal, the storage device of the proxy server can be saved and the files can be transmitted more quickly via a wireless network, whereby the performance of a web browser can be improved correspondingly.

Although preferred embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. A web browser system of a mobile communication terminal, using a proxy server, comprising:
a mobile communication terminal configured to implement decoding and parsing for HTML and CSS binary files transmitted from a proxy server, execute a JavaScript bytecode, decode an image file, and implement rendering for respective results, for the sake of web browsing of a web browser built therein;
a proxy server configured to, in correspondence to a web address transmitted from the mobile communication terminal, transmit a page access command to a web server of the corresponding web address via a wired network, implement grammar indentifying binary encoding for HTML and CSS transmitted from the web server to decrease capacity, convert quality for an image file to decrease capacity, compile JavaScript into a bytecode to decrease capacity, and transmit those files to the mobile communication terminal via a wireless network; and
a web server configured to transmit files constituting a web page including the HTML, CSS, JavaScript and image files, to the proxy server in response to the access command transmitted from the proxy server.

2. The web browser system according to claim 1, wherein the mobile communication terminal comprises:
a CSS binary decoder configured to decode and restore a grammar identification-encoded CSS binary to an original CSS;
a CSS parsing section configured to parse the restored CSS;
a JavaScript bytecode executing engine configured to receive and execute the JavaScript bytecode;
an image file decoding engine configured to receive and execute the image file; and
a rendering section configured to render the HTML, CSS, JavaScript and image files executed as described above, and outputs them to a display device of the mobile communication terminal.

3. The web browser system according to claim 1, wherein the proxy server comprises:
a data type identifying encoder configured to identify a data type from HTML sources inputted from the web server and encode the data type into a binary code;
a tag identifying encoder configured to identify a tag from the HTML sources inputted from the web server and encode the tag into a binary code;
a similar URI collecting section configured to collect a similar URI from the HTML sources inputted from the web server;
a first file compressor configured to compress, the URI collected and transmitted by the similar URI collecting section at a relatively high compression rate and output the compressed URI as a binary code;
a second file compressor configured to compress contents data among the HTML sources inputted from the web server at a relatively low compression rate and output the compressed contents data as a binary code; and
a collecting and streaming output section configured to collect information outputted as binary codes from the respective components and output streaming type HTML binary codes.

4. The web browser system according to claim 3, wherein, when the data type is encoded and is compressed into a binary, the proxy server converts a number represented by characters into an integer to decreases an amount of data.

5. The web browser system according to claim 3, wherein the proxy server implements encoding by using a method in which a succeeding tag is determined according to a preceding tag when encoding an HTML tag.

6. The web browser system according to claim 1, wherein the proxy server receives CSS sources from the web server, implements data type identifying encoding, a block identifying encoding and similar URI collecting and compressing in conformity with data of the CSS sources, collects respective data, and transmits the collected data to the mobile communication terminal in a streaming type.

7. The web browser system according to claim 1, wherein the proxy server consecutively transmits already converted data to the mobile communication terminal while the HTML, CSS and image files are converted.

8. The web browser system according to claim 1, wherein the proxy server transmits a small image file which is referred to by the HTML file using an <img> tag, by including it into the HTML file in the form of DATA URL.

9. The web browser system according to claim 1, wherein the proxy server merges a number of image files to be transmitted to the web browser of the mobile communication terminal, into one image so that the number of HTTP requests and replies is decreased.

10. The web browser system according to claim 1, wherein the proxy server includes an automatic encoding detector which implements automatic encoding detection.

11. The web browser system according to claim 1, wherein the proxy server places behind a JavaScript code which does not exert an influence on an HTML page layout.

12. A web browser system of a mobile communication terminal, using a proxy server, comprising:
a mobile communication terminal configured to implement decoding and parsing for HTML and CSS binary files transmitted from a proxy server, execute a JavaScript bytecode, decode an image file, and implement rendering for respective results, for the sake of web browsing of a web browser built therein;
a proxy server configured to receive main files from a web server corresponding to a web address transmitted from the mobile communication terminal, transmit the main files to the 15 mobile communication terminal, receive files linked with the main files from the web server, transmit the linked files to the mobile communication terminal, and, when the web browser requests again a previously requested web page, transmit prefetched files of the corresponding web page; and
a web server configured to transmit files constituting a web page including the HTML, CSS, JavaScript and image files, to the proxy server in response to the access command transmitted from the proxy server.

13. The web browser system according to claim 12, wherein, when the proxy server transmits the prefetched files, the proxy server transmits the prefetched files by compressing the prefetched files.

14. A web browser system of a mobile communication terminal, using a proxy server, comprising:
a mobile communication terminal configured to implement decoding and parsing for HTML and CSS binary files transmitted from a proxy server, execute a JavaScript bytecode, decode an image file, and implement rendering for respective results, for the sake of web browsing of a web browser built therein, the mobile communication terminal having a local prefetching module and receiving files prefetched in the proxy server before implementing local prefetching;
a proxy server configured to receive main files from a web server corresponding to a web address transmitted from the mobile communication terminal, transmit the main files to the mobile communication terminal, receive files linked with the main files from the web server, transmit the linked files to the mobile communication terminal, and, when the web browser requests again a previously requested web page, transmit prefetched files of the corresponding web page; and
a web server configured to transmit files constituting a web page including the HTML, CSS, JavaScript and image files, to the proxy server in response to the access command transmitted from the proxy server.

15. The web browser system according to claim 14, wherein the local prefetching module analyzes main files of a web page to be accessed, detects address link information of files to be received, transmits an access command generated based on the detected address link information to the proxy server, and receives the corresponding files from a proxy cache.
